(19) United States
(12) Patent Application Publication
(10) Pub. No.: US 2003/0040308 A1
(43) Pub. Date: Feb. 27, 2003

(54) Telecommunication terminals and method for controlling the redirection of calls between telecommunication terminals

(76) Inventor: Arnold Gieseke, Giesen (DE)

Correspondence Address: BELL, BOYD & LLOYD, LLC, P. O. BOX 1135, CHICAGO, IL, 60690-1135, US

(21) Appl. No.: 10/149,741

(22) PCT Filed: Dec. 15, 2000
(86) PCT No.: PCT/DE00/04487

(30) Foreign Application Priority Data
Dec. 17, 1999 (DE) 19960964.0

(51) Int. Cl. H04B 5/00; H04M 3/42; H04Q 7/20

(52) U.S. Cl. 455/426; 455/417; 455/41

(57) ABSTRACT

Telecommunications terminals, and a method for controlling call diversion between such telecommunications terminals, wherein it is guaranteed that a call diversion between the terminals takes place only if it is required, without a user having to spend time on it. Specifically, a stationary telecommunications terminal initiates call forwarding from itself to a mobile terminal if the presence of a recognition signal of the mobile terminal is not detected, and cancels the call forwarding if the presence of the recognition signal following an interruption is again detected.

The invention relates to a stationary telecommunications terminal for connection to a switching node point of a fixed telecommunications network, whereby it comprises a detector to detect the presence of an allocated mobile telecommunications terminal in its vicinity, and whereby the detector comprises a radio receiver, an infrared or ultrasonic receiver, with which a characteristic recognition signal emitted by the mobile telecommunications terminal can be detected.

### STATE OF THE ART

Call diversions from a stationary telecommunications terminal such as a fixed-network telephone to a second terminal are currently manually programmed by the user each time that they are required in that the user specifies a destination telephone number for the diversion on his terminal, which sends a corresponding command to a network node point to which the stationary telecommunications terminal is connected.

As mobile terminals become more and more widespread, this method increasingly fails to meet user requirements. In order to ensure continuous availability of a user who cannot constantly remain in audible range of his stationary telecommunications terminal, this user, on leaving the vicinity of his stationary terminal, would essentially have to program a call diversion on said stationary terminal to a mobile terminal which he carries with him, and would have to cancel this programming on his return. If the user often has to move outside the audible range of his stationary terminal, a procedure of this type is highly time-consuming, and furthermore runs the risk that the user will forget to program a call diversion and will therefore be temporarily unavailable, or will forget to cancel the diversion on his return, so that incoming calls are unnecessarily diverted to the mobile terminal, thereby incurring unnecessary costs for the user.

A telephone system in which a mobile telephone of a cellular radio network emits identification signals by means of which a home base station detects the presence of said mobile telephone is known from GB 2 282 735. The home base station is connected to a country-based fixed-network line telephone system. Only if the mobile telephone is located in the vicinity of the home base station and the latter can detect identification signals of the mobile telephone are calls intended for the mobile telephone diverted via the fixed network to the home base station.

### ADVANTAGES OF THE INVENTION

The present invention proposes telecommunications terminals and a method for call diversion between them which guarantees that a call diversion between the terminals takes place only if it is required, without the user having to spend time on it.

These advantages are achieved according to a first aspect of the invention in a first telecommunications terminal in that the stationary telecommunications terminal is set up in such a way that it initiates call forwarding from itself to the mobile terminal if the detector does not detect the presence of the recognition signal of the mobile telecommunications terminal, and that it cancels the call forwarding if the detector again detects the presence of the recognition signal of the allocated telecommunications terminal following an interruption.

If the user carries the allocated mobile terminal about his person, the first telecommunications terminal thus automatically initiates a call diversion as soon as the user—and with him the mobile terminal—have left the vicinity of the first terminal.

This first terminal is typically a telephone connected to a fixed network, whereby this expression is to be understood generally and may also include cordless telephones such as DECT telephones which are only indirectly connected to the fixed network and can only be used within the range of a specific base station with which they are registered.

The presence of the terminal is appropriately detected in a contactless manner in that the detector comprises a radio, infrared or ultrasonic receiver.

Since a plurality of different mobile terminals may be located at a given time in the vicinity of a first telecommunications terminal, the detector is preferably set up to identify the recognition signal of the allocated terminal from a plurality of recognition signals transmitted by these mobile terminals.

The signals transmitted by the mobile terminal and received by the detector are preferably signals according to the Bluetooth standard. This standard which is currently being developed is intended in particular for the wireless networking of devices in private households. It can therefore be expected that transmitters and receivers for signals of this type will be available in large numbers and at low cost. With the use of Bluetooth, it is also possible to divert the voice communications from the fixed network to the mobile terminal, since the Bluetooth specification provides and plans for voice communications in the standard. However, other LPDs (Low Power Devices) based on different specifications can be also used.

The advantages of the invention are achieved according to a second aspect by means of a mobile telecommunications terminal for receiving and transmitting voice or data signals with a first range, which is set up to transmit a recognition signal which is characteristic of the terminal with a second range which is shorter than the first range. This recognition signal must not be confused with the recognition signal with which, for example, a GSM terminal logs into a mobile telephone network. The range of this latter recognition signal is too long to be suitable as a recognition signal within the meaning of the present invention. It is thus particularly preferable for the invention that the range of the transmitter for the recognition signal is not longer than the distance from which a user can still hear the ringing of a stationary telephone, or from which he can reach a ringing stationary telephone without difficulty before a caller hangs up. An appropriate upper limit for the transmitter range is therefore approx. 30 m.

In a first design of the mobile terminal, the recognition signal is periodically emitted.

The interval at which the transmitter emits the recognition signal represents a compromise between a desirable fast system response capability and the need to minimize the power consumption of the mobile terminal due to the emission of the recognition signal. If a user leaves the vicinity of his stationary terminal, he is unavailable during a period of time which the stationary terminal requires in order to recognize the absence of the mobile terminal and set up the call diversion. From this point of view, it would be desirable to emit the recognition signal at the shortest possible interval. However if this happens too often, it merely shortens the battery life of the mobile terminal without bringing additional benefits. Appropriate limits for the transmit interval of the recognition signal lie within the range from a few seconds to several minutes.

In a second design of the mobile terminal, it is provided that the recognition signal is emitted only if a prompt signal has been previously received. If the mobile terminal is located out of range of the prompt signal generated by the first terminal, it emits no recognition signal and therefore saves its batteries. Further features and advantages of the invention are indicated in the following description of exemplary embodiments with reference to the figure.

### FIGURE

FIG. 1 shows an example of a system of telecommunications terminals according to the present invention.

### DESCRIPTION OF THE EMBODIMENT

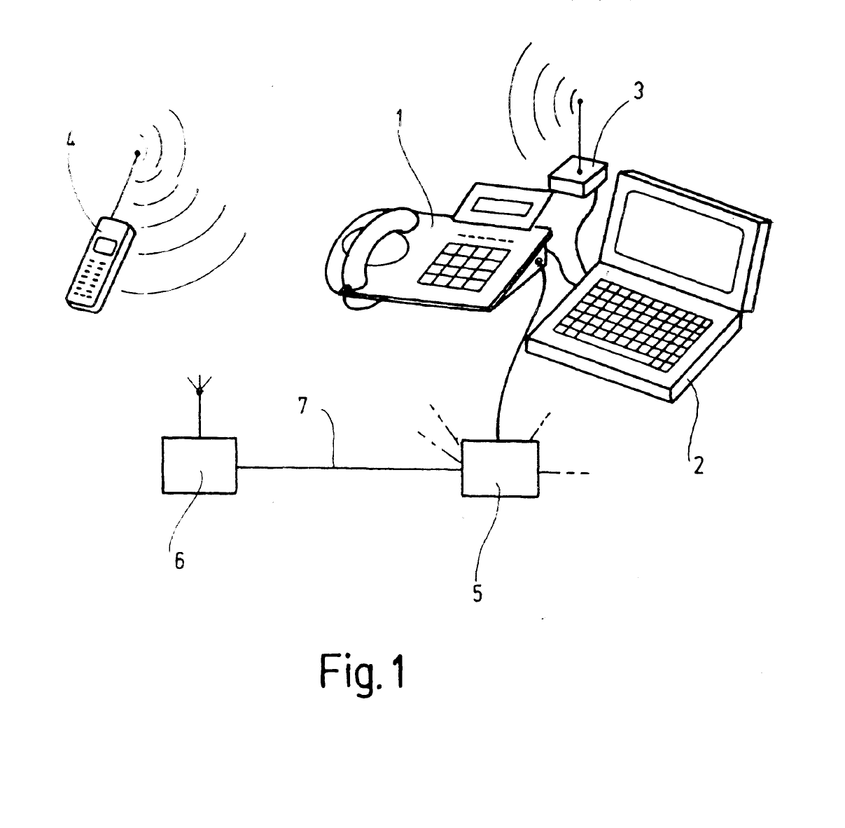

In the example shown in FIG. 1, a fixed-network telephone 1 known per se, a computer 2 and a radio transceiver 3 are combined to form a first telecommunications terminal within the meaning of the present invention. This first terminal is connected to a network node point 5, which may be a private automatic branch exchange (PABX) or a switching office of a public telecommunications network, and via which call connections of the telephone 1 can be handled.

The system shown furthermore comprises a second, mobile terminal 4, which is set up to exchange voice or data with a base station 6 of a mobile radio network on a first radio channel. A cross-connection 7 can be set up between the network node point 5 and the base station 6.

The mobile terminal 4 communicates on a second radio channel with the transceiver 3 as long as both are within range of one another. This may involve simple one-way communications, in which the mobile terminal 4 emits a recognition signal onto the second radio channel at regular time intervals of a few seconds to minutes. This recognition signal is picked up by the transceiver 3 and forwarded in electronic form to the computer 2, which compares it with a predefined recognition signal and, in the event of a match, establishes that the terminal 4 allocated to the telephone 1 is within range. Recognition signals from other terminals (not shown) which may also be located within the range of the transceiver 3 are identified by the computer 2 as not matching and are ignored.

The communications on the second radio channel between the transceiver 3 and the mobile terminal 4 may also run in two directions, in such a way that the transceiver periodically emits a prompt signal, and the mobile terminal, on receiving the prompt signal, responds by emitting its own recognition signal. Reception and processing of the recognition signal by the transceiver 3 and the computer 2 are carried out as described above.

The first variant offers the advantage that the one-way signal transmission can be implemented at lower cost than two-way data transmission. In contrast, the second variant offers the advantage that, if the mobile terminal transmits its recognition signal only when prompted, the power consumption of the mobile terminal is then minimized if it is located out of range of the transceiver 3, since it does not have to transmit a recognition signal at this time. Since this time is in most cases also a time when the mobile terminal 4 must work independently from the network, a longer standby time of the mobile terminal 4 can be achieved in this way.

If the transceiver 3 does not receive an expected recognition signal from the mobile terminal 4, the computer 2 infers that the mobile terminal 4 must have moved out of range of the transceiver 3 and therefore away from the vicinity of the telephone 1. It therefore prompts the telephone 1 to send a command to the network node point 5 to set up call forwarding to the mobile terminal 4. As long as this call diversion is set up, incoming calls intended for the telephone 1 are transferred via the dial-up connection 7 and the base station 6 to the mobile terminal 4. No action is required here on the part of the user of the terminal 4; the call diversion is set up fully automatically as soon as he moves out of range of the transceiver 3 with his terminal 4.

It can also be provided that the call diversion is set up only if an expected recognition signal from the mobile terminal 4 is not received several times in succession. This prevents a call diversion from being unnecessarily programmed if, for example, the user of the mobile terminal is moving within an area with locally differing receive conditions for the recognition signal, but is otherwise located at a distance from which he can still hear the ringing of the telephone 1 and can reach it if necessary.

The ranges of the recognition signal 4 and, where appropriate, the prompt signal emitted by the transmitter 3 are substantially shorter than the range of the radio transmission between the mobile terminal 4 and its base station 6. A range which is too long, for example more than 30 m, is undesirable, since situations may otherwise arise in which a user is so far away from the telephone 1 that he can no longer hear it ringing, but, on the other hand, the transceiver 3 still receives the recognition signal of the mobile terminal 4 which the user carries around with him, and therefore no call diversion is set up.

If, following an absence, the user returns with the mobile terminal 4 to the vicinity of the telephone 1, the periodically emitted recognition signal of the mobile terminal 4 again reaches the transceiver 3 in the case of one-way transmission, or, in the case of two-way transmission, the mobile terminal 4 again receives the prompt signal from the transceiver 3, to which it responds with its recognition signal. The computer 2 recognizes the recognition signal and thereupon prompts the telephone 1 to send a command to the network node point 5 to cancel the call diversion. The call diversion is thus automatically canceled with no action on the part of the user.

It therefore suffices for the user to carry the mobile terminal 4 constantly with him to enable him at any time to receive calls intended for the fixed-network telephone 1.

The signal transmission between the mobile terminal 4 and the transceiver 3 can essentially be performed in any given cordless manner, for example not only by means of radio, but also by means of ultrasonic or infrared signals. However, radio transmission offers the advantage that the same antenna and, under certain circumstances, also the same output stage can be used in the mobile terminal 4 for communication with the transceiver 3 as for communication with the base station 6, thereby saving weight and costs. The transceiver 3 and the mobile terminal 4 can communicate with one another according to the Bluetooth standard. However, other LPD systems can also be used.

The elements telephone 1, computer 2 and transceiver 3 shown in this embodiment as separate components can of course also be combined to form one uniform terminal, whereby the computer can be replaced by a specialized circuit to evaluate the recognition signal.

1. A stationary telecommunications terminal (1) for connection to a switching node point (5) of a fixed telecommunications network, whereby it comprises a detector (2, 3) to detect the presence of an allocated mobile telecommunications terminal (4) in its vicinity, and whereby the detector comprises a radio receiver (3), an infrared or ultrasonic receiver, with which a characteristic recognition signal emitted by the mobile telecommunications terminal (4) can be detected, characterized in that the stationary telecommunications terminal (1) is set up in such a way that it initiates call forwarding from itself to the mobile terminal (4) if the detector (2, 3) does not detect the presence of the recognition signal of the mobile telecommunications terminal (4), and in that it cancels the call forwarding if the detector (2, 3) again detects the presence of the recognition signal of the allocated mobile telecommunications terminal (4) following an interruption.

2. The stationary telecommunications terminal as claimed in claim 1, characterized in that the detector (2, 3) is set up to identify the recognition signal of the allocated terminal (4) from a plurality of recognition signals emitted by different mobile terminals.

3. The stationary telecommunications terminal as claimed in one of the preceding claims, characterized in that the detector (2, 3) is set up to process signals according to the Bluetooth standard.

4. The stationary telecommunications terminal as claimed in one of the preceding claims, characterized in that it comprises a fixed-network telephone (1) or DECT telephone.

5. The stationary telecommunications terminal as claimed in one of the preceding claims, characterized in that the telecommunications terminal (4) has a first range to receive and transmit voice or data signals and in that it is set up to emit a recognition signal characteristic of the terminal with a second range which is shorter than the first range.

6. The stationary telecommunications terminal as claimed in claim 5, characterized in that the second range is not more than 30 m.

7. The stationary telecommunications terminal as claimed in claim 5 or 6, characterized in that the mobile telecommunications terminal (4) has a radio, infrared or ultrasonic transmitter to emit the recognition signal.

8. The stationary telecommunications terminal as claimed in one of claims 5 to 7, characterized in that the mobile telecommunications terminal (4) emits the recognition signal at a transmit interval of several seconds to several minutes.

9. The stationary telecommunications terminal as claimed in one of claims 5 to 8, characterized in that the mobile telecommunications terminal (4) emits the recognition signal in each case in response to the reception of a prompt signal.

10. The stationary telecommunications terminal as claimed in one of claims 5 to 9, characterized in that the recognition signal is a signal according to the Bluetooth standard.

11. A method for controlling call diversion from a stationary (1, 2, 3) to a mobile telecommunications terminal (4), whereby the presence of the mobile terminal (4) in the vicinity of the stationary terminal (1, 2, 3) is checked with the aid of a detector (2, 3), and whereby the detector (2, 3) comprises a radio receiver (3), an infrared or ultrasonic receiver, with which a characteristic recognition signal emitted by the mobile telecommunications terminal (4) is detected, characterized in that a call diversion is set up from the stationary to the mobile terminal if the check reveals that the mobile terminal (4) has left the vicinity of the stationary terminal (1, 2, 3), and in that the call forwarding is cancelled if a further check reveals that the mobile terminal (4) is again located in the vicinity of the stationary terminal (1, 2, 3).

12. The method as claimed in claim 11, characterized in that the stationary terminal (1, 2, 3) decides during the check whether or not the mobile terminal (4) is located in the vicinity, according to whether or not it receives a recognition signal emitted by the mobile terminal (4).

13. The method as claimed in claim 11 or 12, characterized in that the mobile terminal (4) periodically emits the recognition signal.

14. The method as claimed in claim 12 or 13, characterized in that the mobile terminal (4) emits the recognition signal on receiving a prompt signal from the mobile terminal.
